(19) United States
(12) Patent Application Publication
(10) Pub. No.: US 2007/0038513 A1
(43) Pub. Date: Feb. 15, 2007

(54) Automated telecommunication system that enables consumers to place telephone calls free of charge

(76) Inventors: Steven N. Flax, Mullica Hill, NJ (US); Thomas R. Unfreed, Hainesport, NJ (US)

Correspondence Address: STEIN, MCEWEN & BUI, LLP, 1400 EYE STREET, NW, SUITE 300, WASHINGTON, DC, 20005, US

(21) Appl. No.: 11/296,393

(22) Filed: Dec. 8, 2005

Related U.S. Application Data
(60) Provisional application No. 60/706,782, filed on Aug. 10, 2005.

(51) Int. Cl. G06Q 30/00

(52) U.S. Cl. 705/14

(57) ABSTRACT

A method of operating an automated telecommunication system, including accepting an incoming telephone call from a consumer at a location to be identified by the system who is prompted to enter a telephone number of a called party, playing at least one advertisement to the consumer, the advertisement being chosen from a set of advertisements based at least partly upon the geographical location of the consumer and/or preprogrammed logic in the system, connecting the consumer to an advertiser associated with the advertisement and then to the called party or connecting the consumer to only the called party based on a preference of the consumer; and terminating the connection between the consumer and the called party after a predetermined time.

### CROSS-REFERENCE TO RELATED APPLICATIONS

This application claims the benefit of U.S. Provisional Patent Application No. 60/706,782, filed Aug. 10, 2005, the disclosure of which is incorporated herein by reference.

### BACKGROUND OF THE INVENTION

1. Field of the Invention

Aspects of the present invention are directed to an automated telecommunication system that enables consumers to place telephone calls free of charge.

2. Description of the Related Art

The ability of users to make long distance telephone calls has been available for more than a century. Concurrently, the opportunity for businesses to charge those same user's fees for the rights to make those telephone calls has been available for almost as long. As one might expect then, businesses based upon the idea of subsidizing a user's long distance telephone call have sprung up throughout the history of the long distance telephone call. Such businesses have, for example, offered various discounts to users of long distance service plans in return for fees paid up front on a monthly basis or for set fees based on a monthly allocation of minutes, which, if exceeded, would cost the user additional fees.

However, problems have frequently been made apparent with such subsidized long distance telephone services. Among these is a failure of the business offering the subsidy to receive full value for the cost of the subsidized telephone call. Another problem is the difficulty in developing a client base from which to generate fees, while still yet another problem is the continued maintenance of the client base so as to generate repeat business.

Similarly, advertising to particular sub-segments of the population based on certain characteristics of those sub-segments has been employed since the mid-nineteen fifties. Recently, this type of advertising has come to be known as directed advertising since the advertising party directs the advertisement at the sub-segment of the population. Often, such advertising takes the form of direct mailings from, for example, a local grocery store, to the homes in the vicinity of the grocery store in order to induce the people living in those homes to shop at the grocery store as opposed to its competitors.

Such advertising is more cost effective and efficient than other types of advertising such as a national advertising campaign for the grocery store since it is highly unlikely that anyone living outside of the immediate vicinity of the grocery store would shop at the grocery store. Indeed, in many cases, any money spent on such a national advertising campaign would be essentially wasted since that money would not generate any business from non-local shoppers.

Unfortunately, the problems with businesses that rely upon directed advertising are many. One very important problem is that frequently the directed advertising is delivered in an unsolicited manner. In other words, the person to whom the advertisement is sent is not required to do anything affirmatively in order to qualify as a person to be advertised to. Frequently, the unsolicited advertisement, even if it is part of a directed advertisement campaign, actually generates negative sentiment on the part of the person receiving the advertisement against the advertiser.

Telemarketing, though highly profitable, is one type of directed advertising that generates this negative sentiment. Telemarketing refers to the use of a telephone system to solicit prospective customers to buy products or services. The prospective customers are identified and qualified by various means, including past purchase histories, previous requests for information, credit limit, competition entry forms or application forms. Names may also be purchased from another company's customer database, or obtained from a telephone directory or some other public list or forum. The qualification process is intended to find those prospective customers most likely to purchase the product or service being sold or advertised.

Despite the negative sentiment created by telemarketing, the fact that telemarketers have undivided access to customers makes this form of advertising effective. Unfortunately for telemarketing firms, however, recent governmental regulations have sharply diminished the ability of these firms to make unsolicited contact with prospective customers. Thus, there is a need for telemarketers to have access to prospective customers that does not threaten the telemarketers with criminal or civil penalties if they are found to be in violation of the new regulations.

This need is paired with a continued need for companies to be able to conduct directed advertising campaigns in order to generate sales for their products. Moreover, telephone users remain in need for subsidized long distance telephone service to lower the cost of communicating with friends and family.

### SUMMARY OF THE INVENTION

According to an aspect of the invention, a method of providing subsidized long distance telephone service via a reverse telemarketing concept comprises offering free long distance telephone service to users in return for the users agreeing to listen to advertising over the phone.

According to an aspect of the present invention, an automated telecommunication system enables consumers to place telephone calls free of charge in return for one or more of the following: (1) listening to pre-recorded commercial advertising messages targeted to the consumer/caller based on geographic and other demographic information provided by the systems evaluation of the caller's area code, exchange, and then historical system usage; (2) speaking with a telemarketer who is selling goods or services; and (3) providing demographic or other survey information about the consumer and his or her family.

According to an aspect of the invention, a method of operating an automated telecommunication system, comprises accepting an incoming telephone call from a consumer at a location to be identified by the system who is prompted during the incoming telephone call to enter a telephone number of a party to be called; playing at least one advertisement to the consumer, the advertisement being chosen from a set of advertisements based at least partly upon the geographical location of the consumer and/or preprogrammed logic in the system; connecting the consumer to an advertiser associated with the advertisement and then to the party to be called or connecting the consumer to only the party to be called based on a preference of the consumer; and terminating the connection between the consumer and the called party after a predetermined time.

According to this aspect of the invention, the system identifies the consumer via one of caller ID and/or the consumer entering identification information.

The choosing of the advertisement comprises receiving an input from the consumer as to what type of advertisement the consumer wishes to listen to; searching from among the set of advertisements for advertisements that are targeted at the consumer's geographical location; assigning a high priority to any advertisements that the consumer has not listened to recently, or at all; and determining whether system logic dictates the choosing of any particular advertisements from the set of advertisements.

The connecting the consumer to an advertiser associated with the advertisement comprises presenting the consumer with an option of being connected to a call center associated with the advertiser; if the consumer chooses to be connected to the call center, reconnecting the consumer with the system upon a conclusion of the consumer's business with the call center; and prompting the consumer to input the consumer's destination phone number if the consumer has not done so already.

If the consumer chooses not to be connected to the call center, the connecting the consumer to an advertiser associated with the advertisement comprises prompting the consumer to input the consumer's destination phone number if the consumer has not done so already.

The terminating comprises timing a connection between the consumer and the called party; and providing warnings to the consumer that a time limit is approaching and/or that the connection will be terminated.

In addition, the method further comprises prompting the consumer to listen to additional advertisements so as to extend the length of the telephone call.

Further, the consumer may establish an account with the system, the account being accessible to the consumer, and may be identified by the system as an account holder. The account is accessible via an internet web page as a portal for the consumer to access his/her account and to get additional information from the internet. The consumer may add telephone connection time to his/her account by viewing advertisements broadcast over the internet and/or by authorizing a payment over the internet.

In addition, the method further comprises gathering demographic and/or product preference information from the consumer.

According to another aspect of the invention, an automated telecommunication system connected to a Public Switched Telephone Network (PSTN) and/or an IP Network, comprises a free call system to receive toll free telephone calls from consumers, to play at least one advertisement to the consumer, the advertisement being chosen from a set of advertisements based at least partly upon a geographical location of the consumer and/or preprogrammed logic in the system, to gather demographic and/or survey information from the consumer, and/or to connect the consumer to a called party for a predetermined period of time; a first node from which the consumer makes the toll free call into the free call system; and a second node at which the called party receives the connected consumer.

According to this aspect of the invention, the free call system comprises an inbound path, which carries a voiceband signal to a Dual Tone Multi-Frequency (DTMF) Detector and an Automated Speech Recognition (ASR) module, respectively; and an outbound path, controlled by a switch which is in turn controlled by a central processor, connected to a recorded message storage or a Text to Speech Synthesizer (TSS).

The system employs at least one of the connection to the PSTN to connect calls over the PSTN and the connection to the IP network to connect calls via the internet. The system automatically determines whether to route the call via a PSTN or a VoIP network based upon the destination of the call, cost, and network availability.

The consumer establishes an account with the system, the account being accessible to the consumer. The account is accessible via an internet web page as a portal for the consumer to access his/her account and to get additional information from the internet. The consumer may add telephone connection time to his/her account by viewing advertisements broadcast over the internet and/or by authorizing a payment over the internet.

According to still yet another aspect of the invention, a method of operating an automated telecommunication system, comprises accepting an incoming telephone call from a consumer to be identified by the system, the consumer being prompted during the incoming telephone call to enter a telephone number of a party to be called, playing at least one advertisement to the consumer, the advertisement being chosen from a set of advertisements based upon the identity of the consumer and/or preprogrammed logic in the system, connecting the consumer to an advertiser associated with the advertisement and then to the party to be called or connecting the consumer to only the party to be called based on a preference of the consumer, and terminating the connection between the consumer and the called party after a predetermined time, wherein the connecting the consumer to the called party comprises routing the connection over a Voice over IP (VoIP) network.

The routing comprises automatically determining whether to route the call via a Public Switched Telephone Network (PSTN) or a VoIP network based upon the destination of the call and network availability. In addition, the routing comprises employing first and second gateways associated with the system, the first gateway being local to the system and the second gateway being local to the called party.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a system of interconnected consumers, called parties, and telemarketers;

FIG. 2 is a second schematic view of a system of interconnected consumers, called parties, and telemarketers;

FIG. 3 is a third schematic view of a system of interconnected consumers, called parties, and telemarketers;

FIGS. 4 and 4A are diagrams of methods of operation of the Free Call System according to embodiments of the invention;

FIG. 5 is a diagram of a method of operation of the Free Call System where a consumer's caller ID is not available;

FIG. 6 a diagram of a method of operation of the Free Call System according to another embodiment of the invention;

FIG. 7 is a schematic view of a website associated with an operation of the Free Call System according to an embodiment of the invention;

FIG. 8 is a schematic view of the Free Call System according to an embodiment of the invention; and

FIG. 9 is a diagram of a method of operation of the Free Call System according to an embodiment of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to an embodiment of the invention, an automated telecommunication system enables consumers to place telephone calls free of charge in return for one or more of the following: (1) listening to pre-recorded commercial advertising messages targeted to the consumer/caller based on geographic and other demographic information provided by the system's evaluation of the callers area code, exchange, and then historical system usage; (2) speaking with a telemarketer who is selling goods or services; and (3) providing demographic or other survey information about the consumer and his or her family. Primarily, the service provides a reverse telemarketing aspect that allows a caller to opt-in to a telemarketing scenario after hearing a pre-recorded commercial. Also of importance is the use of Voice over Internet Protocol which translates a traditional telephone call into a digital call processed for distribution using the internet.

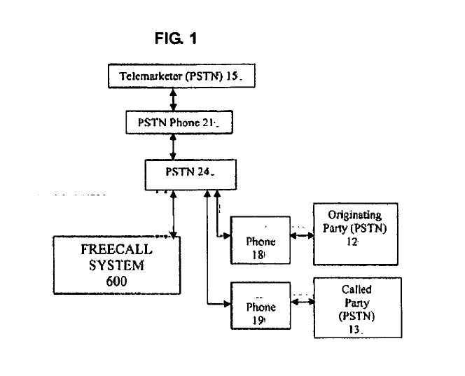

With reference to FIGS. 1-3, embodiments of the automated telecommunication system (hereinafter referred to as the “system” or “Free Call System”) 600 according to the present invention are shown. With reference to FIGS. 1-3, it is noted that the system 600 may be connected to the Public Switched Telephone Network (PSTN) Local Exchange Carrier (LEC) via analog Plain Old Telephone Service (POTS) lines or via digital trunks such as T-1 or E-1 carriers. The POTS or digital trunks may be used for both incoming and outgoing phone calls.

With reference to FIG. 1, an embodiment of the system 600 discussed above will now be described. As shown in FIG. 1, all parties, including an originating party 12, a called party 13, and a telemarketer 15, may place or receive calls using phones 18, 19, and 21, respectively, (hereinafter referred to as “telephones”) which are connected to the Public Switched Telephone Network (PSTN) via the PSTN 24. In detail, the originating party 12 uses telephone 18 to place a call to the Free Call System 600 via the PSTN 24. The Free Call System 600 performs interactive voice response operations that will be discussed in detail below and connects the originating party 12 to a called party 13 via the PSTN 24.

Alternatively, the Free Call System 600 may also connect the originating party 12 to the telemarketer 15 via the PSTN 24. In addition, the Free Call System 600 may connect the originating party 12 to an internal interactive voice response (IVR) technology system (to be discussed below) for the purpose of gathering information about the originating party 12.

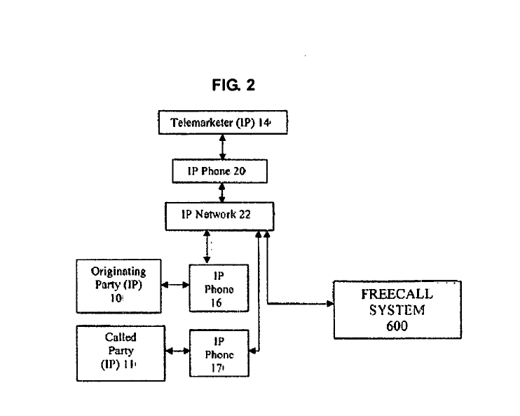

With reference to FIG. 2, another embodiment of the system discussed above will now be described. As shown in FIG. 2, all parties, including an originating party 10, a called party 11, and an IP telemarketer 14, may place or receive calls using IP phones 16,17, and 20, respectively, which are phones that are connected to the Internet Protocol (IP) network 22 (and which are hereinafter referred to as “IP phones”) via the IP network 22. In detail, the originating party 10 uses IP phone 16 to place a call to the Free Call System 600 via the IP network 22. As in the embodiment discussed above, the Free Call System 600 performs interactive voice response operations that will be discussed in detail below and connects the originating party 10 to a called party 11 via the IP network 22.

Alternatively, the Free Call System 600 may also connect the originating party 10 to the IP telemarketer 14 via the IP network 22. In addition, the Free Call System 600 may connect the originating party 10 to an internal IVR system (to be discussed below) for the purpose of gathering information about the originating party 10.

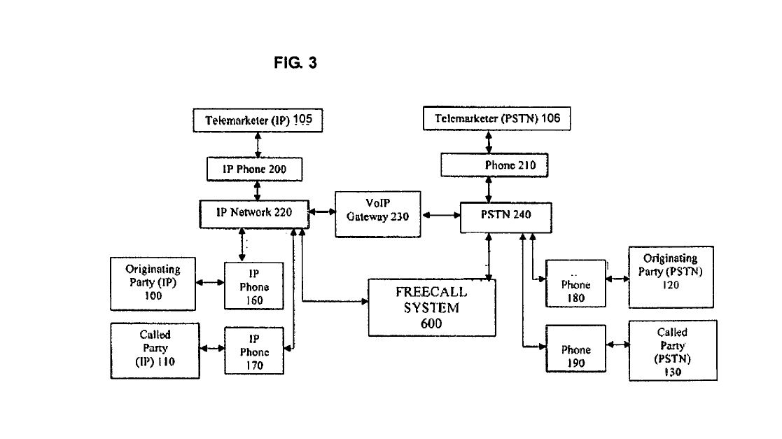

Of course a third embodiment of the system is possible. With reference to FIG. 3, this embodiment of the system 1 will now be described. As shown in FIG. 3, all parties, including originating parties 100 and 120 using phones 160 and 180, respectively, called parties 110 and 130 using phones 170 and 190, respectively, and telemarketers 105 and 106, using phones 200 and 210, respectively, may place or receive calls via either the PSTN 240 or the IP network 220. An originating party 100 or 120 uses IP phone 160 or telephone 180, respectively, to place a call to the Free Call System 600 via either the PSTN 240 or the IP network 220. The Free Call System 600 performs interactive voice response operations that will be discussed in detail below and connects the originating party 100 or 120 to a called party 110 or 130 via the PSTN 240, the IP Network 220 or a combination thereof. If a call is placed between a PSTN party and an IP party, a VoIP Gateway 230 provides an interface between the IP Network 220 and the PSTN 240. If both parties are IP parties, the call may be routed directly via the IP network, or via a combination of the IP network and PSTN.

Alternatively, the Free Call System 600 may also connect the originating party 100 or 110 to the IP telemarketer 105 or the telemarketer 106 via either the IP network 220 or the PSTN 240 or a combination thereof. In addition, the Free Call System 600 may connect the originating party 100 or 120 to an internal IVR system (to be discussed below) for the purpose of gathering information about the originating party 100 or 120.

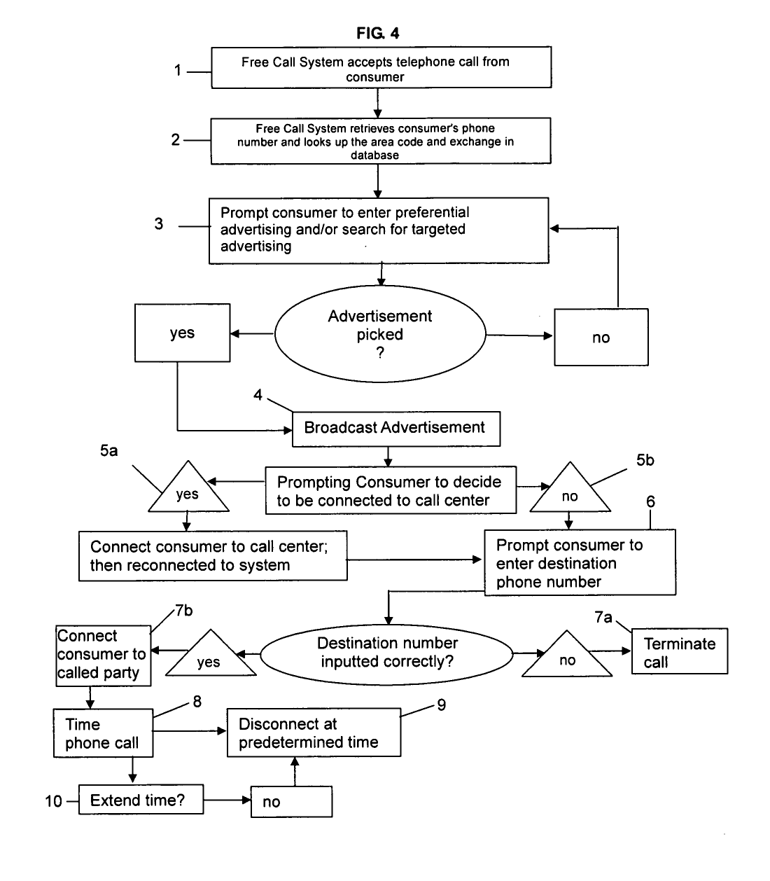

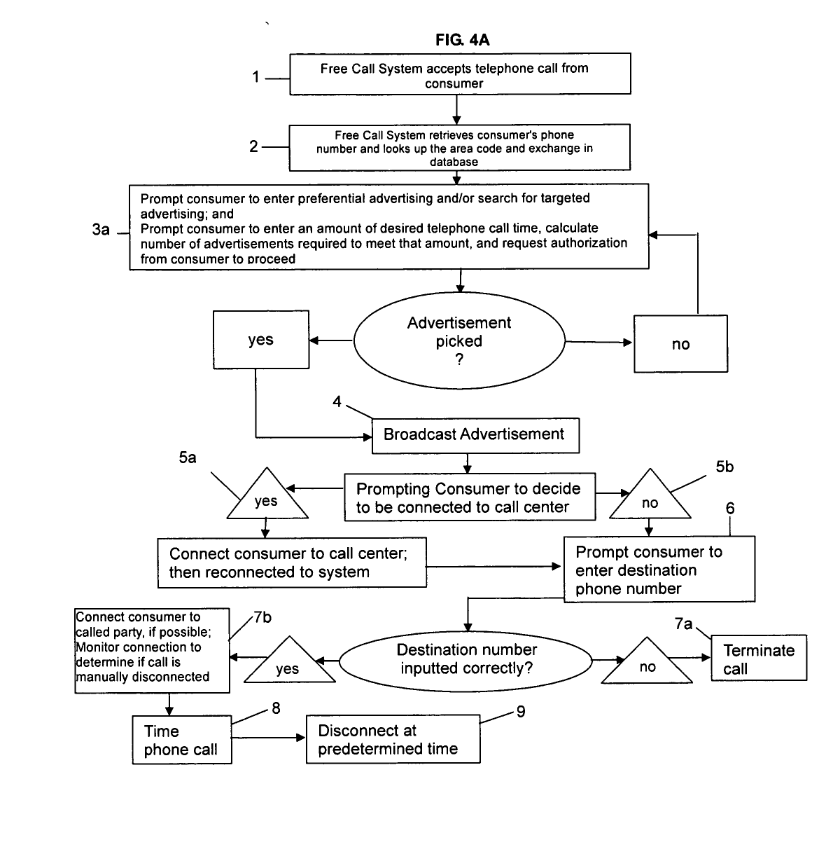

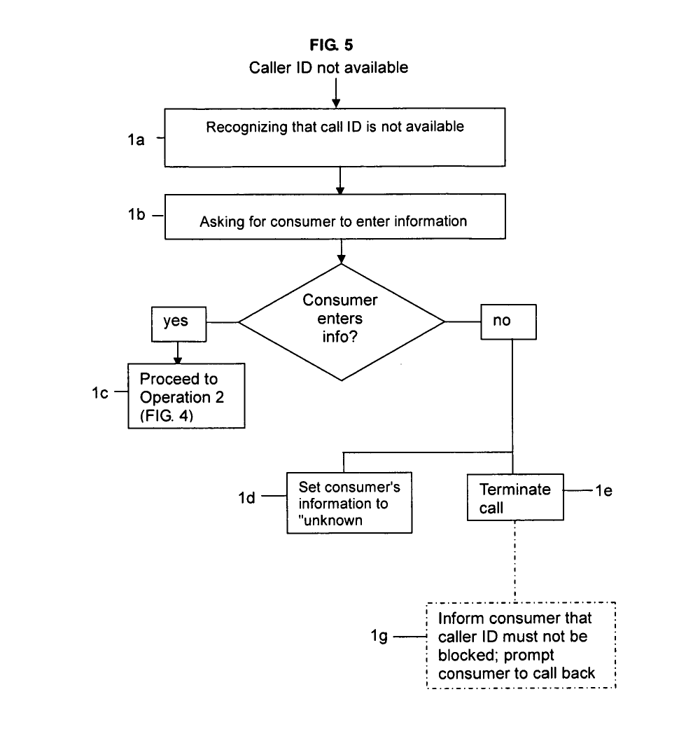

With reference to FIGS. 4 and 5, an embodiment of a method of operation of the Free Call System 600 will now be described. Initially, as shown in FIGS. 1-3 in which originating parties 10 or 12 are illustrated as placing calls, the originating parties 10 or 12, who may now be considered consumers, dial into the Free Call System 600 using toll-free phone numbers, such as 800 numbers in the United States. As shown in FIGS. 1-3, these toll free phone calls may be made with either a telephone 18 or an IP phone 16. The Free Call System 600 is alerted to the incoming call via a ring signal if the call is received on an analog line or via Common Channel Signaling (CCS) or Channel Associated Signaling (CAS) if the call is received on a digital line.

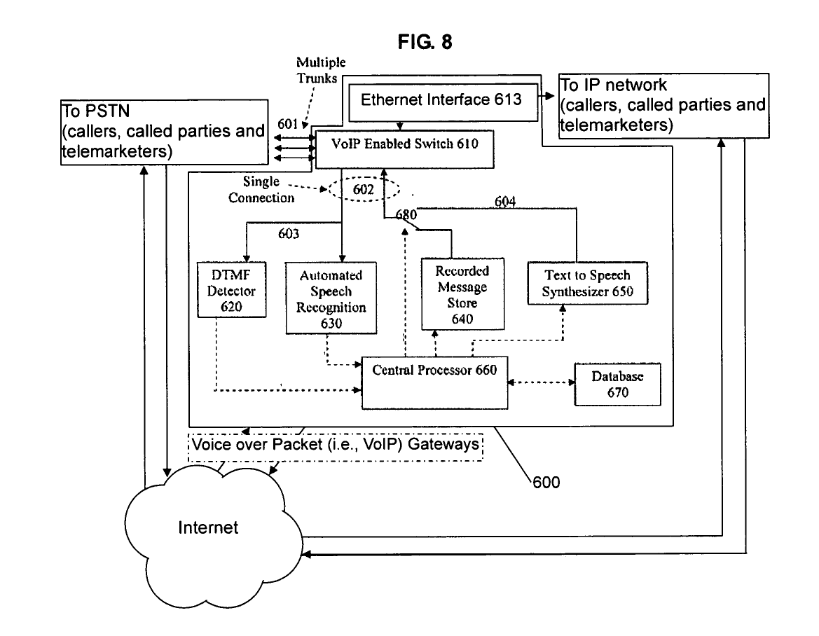

As illustrated in FIG. 4, the Free Call System then accepts the call (operation 1). Next, the Free Call System 600 retrieves the consumer's phone number and looks up the area code and exchange in a database (reference numeral 670 in FIG. 8 and to be described below) that relates combinations of area codes and phone numbers with geographical locations, such as towns, cities, or zip codes, so as to determine the consumer's geographical location (operation 2).

If Caller ID information is not available, as shown in FIG. 5, the Free Call System 600 recognizes that caller ID is blocked or not available (operation 1a). Here, the Free Call System 600 may ask the consumer to enter his/her phone number and/or geographical location via Dual Tone Multi Frequency (DTMF) inputs or by speaking the information (operation 1b). Once the consumer enters this information, the system 600 proceeds to operation 2 (operation 1c). If the consumer chooses not to enter his/her information, the system 600 may then either set the consumer's information to an “unknown” state (operation 1d) or terminate the call altogether (operation 1e). If the system 600 terminates the call, the system may first inform the consumer that caller ID must not be blocked or that the information discussed above is necessary to proceed (operation 2f), and, second, may prompt the consumer to call back once caller ID has been enabled (operation 1g).

Referring back to FIGS. 4 and 4A, once the Free Call System 600 retrieves the consumer's phone number and determines the consumer's geographical location, the Free Call System 600 either prompts the consumer to enter a preference for a type of advertisement the consumer may want to listen to or begins to search its database 670 for advertisements that are targeted at the consumer's geographical location (operation 3). The Free Call System 600 makes a list of these advertisements and sorts the list according to which advertisements are most directly targeted at the consumer's geographical location. For example, if the Free Call System 600 determines that the Consumer is located in Washington, DC, and then determines that there are available advertisements for businesses in the Washington metropolitan area, the Philadelphia metropolitan area and the New York metropolitan area, the Free Call System 600 assigns the highest priority to those advertisements for businesses in the Washington, DC metropolitan area.

The listening history of the consumer may also be used to determine priority of advertising content. As such, the database 670, or an additional database, may also record which advertisements the consumer has listened to most recently by recording identification information of each advertisement heard by the consumer, the consumer's phone number and geographical location, and the dates and times of the consumer's phone calls into the system database 670. The most recently listened to advertisements are then given low priority whereas advertisements that the consumer has not listened to recently, or at all, are given high priority. Thus, if the system 600 determines that it is appropriate to play an advertisement targeted to Washington, DC, the use of the consumer's listening history will additionally determine which advertisement, among those advertisements directed at the Washington, DC metropolitan area, the consumer has not heard in a long time, if ever. The system 600 then determines which advertisement to play at least partly based on the consumer's listening history.

If all advertisements have been played to the consumer recently or there are no targeted advertisements available for the geographical location of the consumer, the Free Call System 600 searches the database 670 for non-targeted advertisements. Once again, these advertisements may be sorted into a list according to how recently the consumer has heard the advertisement, from most recent to least recent. If at least one advertisement has not been heard recently by the consumer, the first advertisement in the list is selected as a suitable advertisement for this consumer.

In an embodiment of the invention, the system 600 may employ logic to distribute advertisements throughout the system 600. Alternately, this logic may be used to give precedence to specific advertisements. In this case, the logic may be based on, for example, increased fees paid by advertisers to increase the incidence that the advertisements associated with the advertiser are played. Of course, there are additional arrangements that may be made on which the logic may be based on and which are covered by the scope of this application.

Referring again to FIG. 4, once the Free Call System 600 chooses which advertisement to play, the chosen advertisement is broadcast to the consumer over the telephone (operation 4). Upon the conclusion of the advertisement, the consumer will then have the option of connecting to a call center associated with the advertiser (operation 5). If the consumer chooses to be connected to the call center, the consumer is connected to the call center (operation 5a) and the Free Call System 600 records the consumer's decision. At the conclusion of the consumer's business with the call center, the consumer is reconnected with the Free Call System 600 and prompted to input the consumer's destination phone number (operation 6). If, on the other hand, the consumer has chosen not to be connected to the call center, the consumer is immediately prompted to input the consumer's destination phone number (operation 5b) and the Free Call System 600 records the consumer's decision (operation 6).

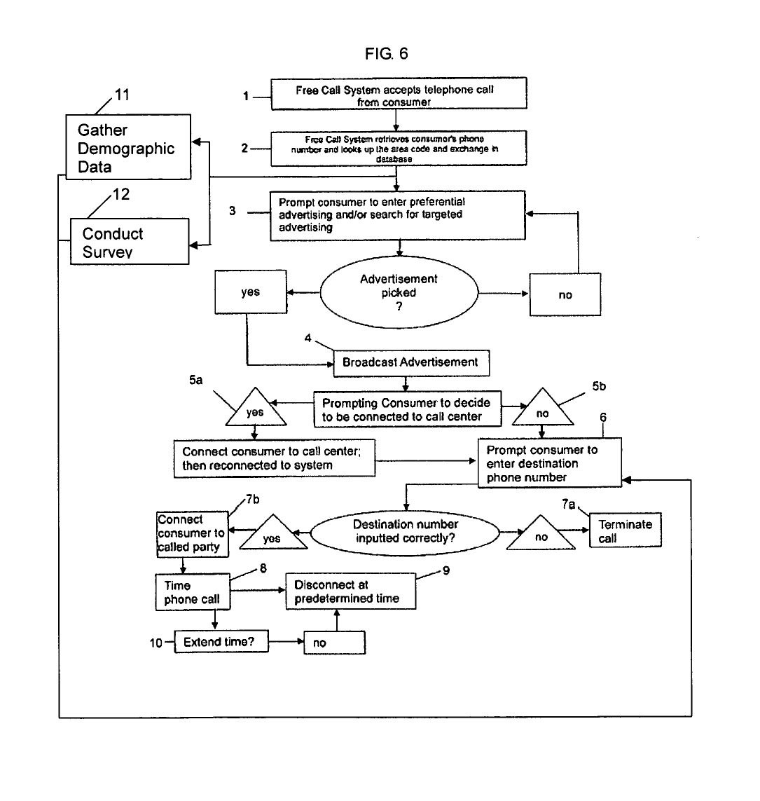

Here, it is noted that while the above discussion and FIGS. 4 and 6 indicate that the consumer is prompted to enter the telephone number of the party to be called after hearing the advertisement and deciding whether to be connected to the advertiser, the invention is not limited to this sequence. In fact, it is understood that the consumer may be prompted to enter the phone number of the party to called at any point during the telephone call including, the moments after the incoming telephone call is accepted buy the system 600, the moments after the playing of the advertisement, moments after the consumer finishes his/her business with the advertiser, or if the consumer chooses to be connected only to the party to be called, the moments after that decision.

If the destination number is not properly inputted after a predetermined number of iterations or a predetermined amount of time, the Free Call System 600 will time out the consumer and the call will be terminated (operation 7a). The time out operation should provide the consumer with a sufficient amount of time to attempt to input the destination phone number and/or several warnings that the consumer is about to be timed out.

On the other hand, once the destination phone number is inputted, the Free Call System 600 connects the consumer with the called party at the destination phone number (operation 7b). Of course, it is understood that if the called party is unavailable the customer is credited for his unused time and invited to complete his/her telephone call at another time at which he may be able to opt out of listening to further advertising. Upon a connection to the called party, the Free Call System 600 will time the phone call (operation 8) and disconnect the phone call once the time of the phone call reaches a predetermined time (operation 9). It is, of course, understood that the system will provide a predetermined number of warnings before the phone call is disconnected. It is also understood that if either the consumer or the called party manually disconnects the telephone call, or if the telephone call is disconnected accidentally, any remaining time available to the customer is credited to the customer as discussed above.

Before disconnection, the consumer may be prompted to listen to additional advertisements so as to extend the length of the telephone call (operation 10). If the consumer chooses to extend the telephone call, the Free Call System 600 may advise the called party that they will be put on hold and may play a second advertisement to the consumer. Alternatively, the advertisement may simply be broadcast to the called party as well. If on the other hand, the consumer chooses not to extend the telephone call, the Free Call System 600 proceeds to disconnection (operation 10). Once the call is terminated (operations 7a or 10), the free call System records the consumer's choices and the length of the consumer's telephone call.

According to an embodiment of the invention, the system 600 may be programmed such that the basic call model does not exceed 11 minutes. Within that arrangement, 1 minute would be devoted to two thirty second commercials and ten minutes of call transfer time.

However, along the lines of the embodiment of the invention in which the consumer has the chance to extend his/her call time, it is understood that the consumer may also have the opportunity to designate the number of advertisements he/she wishes to listen to so as to preemptively secure a predetermined amount of additional telephone call time beyond the 11 minutes as discussed above. In other words, if the consumer wishes to secure 30 minutes of additional telephone call time, the consumer may instruct the system 600 to play a sufficient number of advertisements so as to build up his/her allocated number of minutes. Further, it is understood that the opportunity to secure a desired amount of telephone time may be available to the consumer at the beginning of the consumer's original telephone call into the system 600, as shown with reference to reference numeral 3a in FIG. 4A (all other reference numerals refer to the same as operations as in FIG. 4). The advantage here being that the consumer's connection to the called party does not have to be interrupted by the system 600 asking the consumer of the consumer desires additional telephone call time and then forcing the called party to either “hang on” while the consumer listens to advertisements or to themselves listen to the advertisements. Indeed, as shown in FIG. 4A, once the telephone call time reaches the predetermined time as calculated at operation 9, the call is disconnected.

Another embodiment of the invention is illustrated in FIG. 6. Here, like elements, features, and operations with FIGS. 4 and 5 will not be re-explained. As shown in FIG. 6, after the Free Call System 600 retrieves the consumer's phone number and determines the consumer's geographical location, the Free Call System 600 either searches its database 670 for advertisements that are targeted at the consumer's geographical location (operation 3), enters into a process by which demographic information is gathered (operation 11), or begins to conduct a survey (operation 12) of the consumer's product preferences.

If the Free Call System 600 chooses to begin operation 3, the method continues according to the embodiments described above. However, if the system 600 begins either operation 11 or 12, as shown in FIG. 6, the system 600 performs the gathering of the demographic information, which may include information such as the consumer's age, ethnicity, geographic location, income, etc. or conducts the survey in which the consumer may be asked what types of products or services the consumer is likely to be interested in. In either case, upon completion of the gathering of the demographic information or the conducting of the survey, the Free Call System 600 then records the information gleaned from the consumer (operation 13) for use during later calls or to provide to potential advertisers in return for a fee.

While FIG. 6 illustrates that the gathering of demographic data (operation 11) and the conducting of the survey (operation 12) are different operations and occur independently of one another, according to an embodiment of the invention, operations 11 and 12 may be performed either simultaneously or sequentially. Of course it is understood that whether these operations can be performed simultaneously or sequentially is a question to be determined based on an amount of time that is predetermined as being a reasonable amount of the consumer's call time.

It is also understood that the question of whether the Free Call System 600 adopts the method according to the embodiment of FIGS. 4 and 5 or FIG. 6 may be determined based on whether the consumer is a first time caller to the system 600. If the consumer is a first time caller to the system 600, the system 600 may determine that gleaning demographic or survey information from the consumer on the first call is more valuable than exposing advertisements to the consumer based solely on the geographic location of the consumer that the system 600 understands from the consumer's phone number. In other words, it is more likely that the system will be able to pick advertisements that are more directly targeted towards the consumer, and thus, more valuable to the advertiser, upon the consumer's subsequent calls into the system 600 if the system 600 has the consumer's demographic and/or survey information on file.

In another embodiment of the invention, the Free Call System 600 may allow the consumer to establish an account with the system 600. Such an account would be accessible to the consumer via internet, email, telephone, regular mail service, or a combination thereof. The system 600 would maintain a database associated with a pin number of the consumer so that the consumer could access his/her account from various telephones numbers. In addition, the consumer would have the ability to add telephone call time to his or her account by simply listening to advertisements over whatever telephone the consumer is using, by watching advertisements online via an internet connection, by paying predetermined fee, or a combination thereof. The consumer, having established a sizable bank of telephone minutes could then call the system 600, bypass the methods described above with reference to FIGS. 4-6 by entering his/her pin number at a prompt, and then complete a call at any time. Such a call would then have an automatically and, likely, a substantially extended available call time.

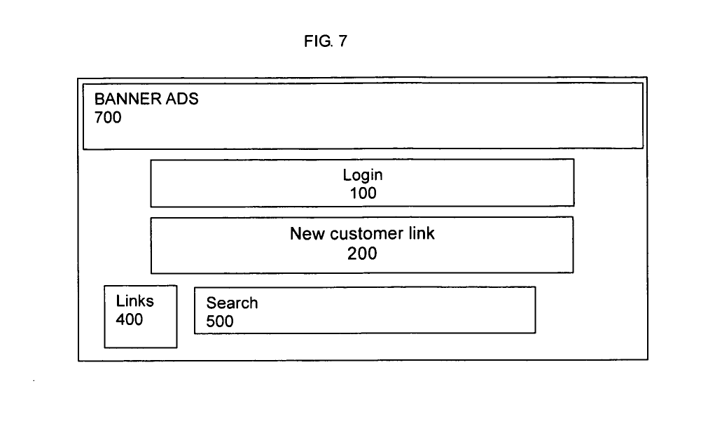

It is understood that a website, such as that which is described above, may be employed as a portal for consumers to access their accounts and to get additional information from the internet as needed. FIG. 7 provides an exemplary view of such a website. As shown in FIG. 7, the website would provide a field 100 for a consumer to enter a login so as to access his/her account and an additional field including a link 200 for new consumers that would lead to a registration page. In addition, the website may include a search function 500 and links 400 to common interest websites. Additional fields 700 may be available for banner ads from which additional advertising revenue may be gleaned.

According to this embodiment of the invention, once a returning consumer has entered his/her login, or a new consumer has registered for an account, the consumer may be directed to a new web page, where the consumer may monitor his/her account. Here, links to advertisements, links to a web page where the consumer may add telephone time by paying directly, links to a web page where the consumer may monitor his/her account, and links to consumer surveys may be made available to the consumer.

It is understood that if the consumer chooses to view ads by clicking on the links, another web page, devoted to playing the advertisement, will open. At that point, the consumer may opt to play the advertisement by hitting a play button or a play link. During the playing of the advertisement, the consumer will have the option of pausing or stopping the playing at any time. In addition, a link to the advertiser's web page or to a web page devoted to the product being advertised would be made prominent. Once the advertisement is completed, the consumer will have the option of accessing the advertiser's web page or the web page devoted to the product being advertised or of closing the web page devoted to playing the advertisement and returning to the account. Meanwhile, the Free Call System 600 will record that the consumer has accessed and played the advertisement online and added a predetermined amount of available call time to the consumer's account.

It is further understood that if the consumer chooses to access the web page where the consumer may add telephone time by paying directly, still yet another new web page devoted to presenting fields into which the consumer may enter payment information will open. Such a web page will provide fields to enter an amount of desired additional call time, field to enter credit card information associated with the amount of desired call time, and fields for verifying the credit card user's identity.

According to another embodiment of the invention, the Free Call System 600 may be made available to users of public pay telephones. As such, the option of dialing into the Free Call System 600 with a toll free number will be shown in the instructions listed on the phone. Once the consumer dials the toll free number, the system 600 will operate in much the same method as that which is described above with reference to FIGS. 4 and 5.

With reference to FIG. 8, a schematic illustration of the Free Call System 600 will now be described. As illustrated, an automated telecommunication system connected to a Public Switched Telephone Network (PSTN) and/or an IP Network, comprises a free call system to receive toll free telephone calls from consumers, to play at least one advertisement to the consumer, the advertisement being chosen from a set of advertisements based at least partly upon a geographical location of the consumer and/or preprogrammed logic in the system, to gather demographic and/or survey information from the consumer, and/or to connect the consumer to a called party for a predetermined period of time, a first node from which the consumer makes the toll free call into the free call system, and a second node at which the called party receives the connected consumer.

The Free Call System connects to callers, called parties and telemarketers using the Public Switched Telephone Network (PSTN) via multiple analog or digital trunks 601 as well as to callers, called parties, and telemarketers using the IP Network via an Ethernet Interface 613. The trunks 601 and Ethernet Interface 613 connect to switch 610. Switch 610 routes PSTN trunks and IP packet circuits to individual circuits (602, for example).

Each circuit 602 has an inbound path 603, which carries a voiceband signal to Dual Tone Multi-Frequency (DTMF) Detector 620 and an Automated Speech Recognition (ASR) module 630, respectively. The DTMF Detector 620 monitors the voiceband signal 603 for the presence of DTMF tones. When a tone is detected, DTMF Detector 620 forwards the identified tone to a central processor 660. Similarly, the ASR module 630 monitors the voiceband signal for speech signals. Each time a word is identified, the word is sent to the control processor 660.

Each circuit 602 also has an outbound path 604. The source of this path is controlled by switch 680 which is in turn controlled by the central processor 660. The outbound path 604 may either connect to recorded message storage 640 or the Text to Speech Synthesizer (TSS) 650. The control processor 660 instructs each of these units to play a speech selection out to the outbound voice path.

Central Processor 660 interprets DTMF digits and interpreted speech in the context of the Interactive Voice Response process, and stores information in the database 670 for later use. Database 670 also stores information that is used to convert phone numbers to geographical regions, as well as information about available advertisements, number of times they should be played and to whom, and to whom they have been played, as well as survey information and other information that is collected and stored for later extraction, as discussed above.

In addition, the Free Call System 600 also operates an associated website on the Internet, as shown. This website is available to be accessed by callers, called parties, and telemarketers whether these groups access the system via the PSTN or the IP network. Further, the website provides each of the groups with access to the system so that individual members of these groups may establish accounts and/or modify their existing accounts via the Internet.

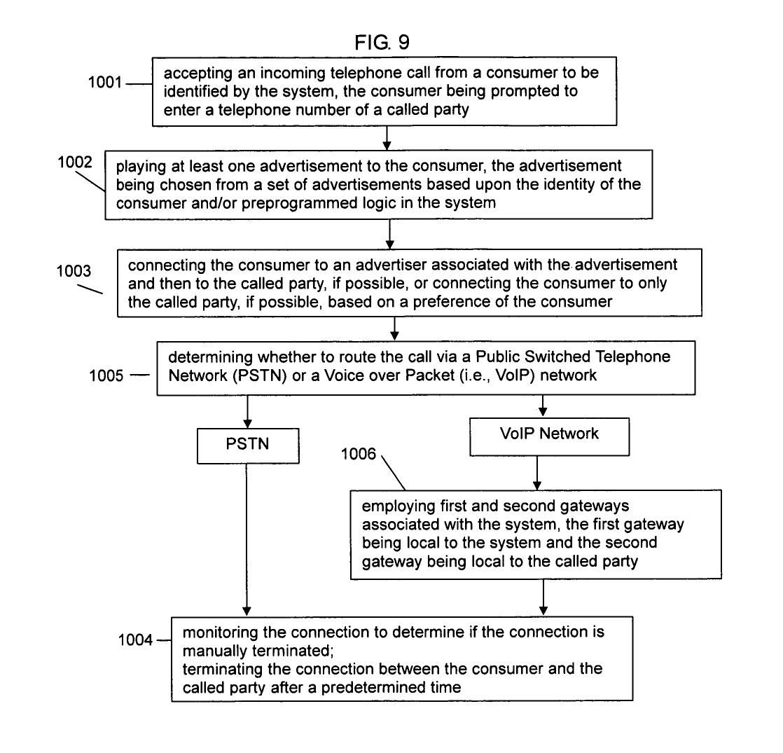

In an embodiment of the invention, illustrated in FIG. 9, the Free Call System 600 may employ the capability to use Voice Over Packet technology to place phone calls via the internet, thereby saving some of the cost of the toll call. Voice Over Packet technology refers to Voice over IP (VoIP) technology, Voice over ATM technology, Voice over Frame Relay technology, etc., and/or a combination thereof. According to this embodiment, in which VoIP will be used as an exemplary network, the method of operating an automated telecommunication system, comprises accepting an incoming telephone call from a consumer to be identified by the system, the consumer being prompted to enter a telephone number of a called party (operation 1001), playing at least one advertisement to the consumer, the advertisement being chosen from a set of advertisements based upon the identity of the consumer and/or preprogrammed logic in the system (operation 1002), connecting the consumer to an advertiser associated with the advertisement and then to the called party or connecting the consumer to only the called party based on a preference of the consumer (operation 1003), and terminating the connection between the consumer and the called party after a predetermined time (operation 1004), wherein the connecting the consumer to the called party comprises routing the connection over a Voice over IP (VoIP) network.

The routing comprises automatically determining whether to route the call via a Public Switched Telephone Network (PSTN) or a VoIP network based upon the destination of the call and network availability (operation 1005). In addition, the routing comprises employing first and second gateways associated with the system, the first gateway being local to the system and the second gateway being local to the called party (operation 1006).

In greater detail, the system 600 decides whether to route the call via a PSTN or a VoIP network based upon the destination of the call and network availability. For example, an international phone call via the PSTN may be cost prohibitive, but an international phone call via a VoIP network should be far more cost effective.

Also, the system 600 will have VoIP gateways, such as that which is shown in FIGS. 2 and 3, or will be contractually connected to VoIP gateways in many locations. That way, if a consumer in Washington, DC calls into the system 600, and wishes to be connected to, say, a PSTN connected telephone number in London, the system 600 may recognize that it will be cost effective to route the call once via a VoIP network. In London, the VoIP gateway receives a signal from the system and then, since the VoIP gateway in London is connected to the London area PSTN, connects the consumer with the telephone number in London at local telephone call rates.

In accordance with this invention, it is understood that the Free Call System 600 could itself act as the VoIP gateway, as shown in FIG. 8, where the system 600, as described above, additionally includes the necessary software programming and hardware. Indeed, according to an embodiment of the invention, with enough systems in place at various geographic locations, a need to contract with external VoIP gateways would be alleviated. Furthermore, it is understood that this invention contemplates the use of Voice Over Packet Network (VOPN) technology as opposed to or in combination with VoIP.

Lastly, it is noted that there are still more applications to which the various embodiments of the present invention may be applied to. One such application is that employment advertisements may be played to a targeted audience in a particular geographical region at particular times of days. The advertisements could be played, for example, when trying to hire a part-time person for a particular shift. The advertisements would be programmed to play in those geographical regions surrounding the location of the job at the time of the shifts so as to guarantee that people who may be looking for that type of work may be home to hear the advertisements.

Another application is the use of promotional codes. Here, a company advertises the phone number of the free call system 600 and provides a promotional word or code. When a caller calls into the system they are prompted to enter or say the promotional word or code, which would initiate the playing of a certain ad or type of ad.

Still yet another application is the use of toll-free advertising lines for specific purposes. As an example, an employment advertisement may be hosted on a separate toll-free number. The free call system 600 either directs the advertisement on a targeted basis or plays everyone who calls the number the same advertisement. This application may be applied to traffic reports, stock information, and political advertising, to name just a few possibilities.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of operating an automated telecommunication system, comprising:
accepting an incoming telephone call from a consumer at a location to be identified by the system who is prompted during the incoming telephone call to enter a telephone number of a party to be called;
playing at least one advertisement to the consumer, the advertisement being chosen from a set of advertisements based at least partly upon the geographical location of the consumer and/or preprogrammed logic in the system;
connecting the consumer to an advertiser associated with the advertisement and then to the party to be called or connecting the consumer to only the party to be called based on a preference of the consumer; and
terminating the connection between the consumer and the called party after a predetermined time.

2. The method according to claim 1, wherein the system identifies the consumer via one of caller ID and/or the consumer entering identification information.

3. The method according to claim 1, wherien the choosing of the advertisement comprises:
receiving an input from the consumer as to what type of advertisement the consumer prefers to listen to;
searching from among the set of advertisements for advertisements that are targeted at the consumer's geographical location and preferences;
assigning a high priority to any advertisements that the consumer has not listened to recently, or at all; and
determining whether system logic dictates the choosing of any particular advertisements from the set of advertisements.

4. The method according to claim 1, wherein the connecting the consumer to be connected to an advertiser associated with the advertisement comprises:
presenting the consumer with an option of being connected to a call center associated with the advertiser;
if the consumer chooses to be connected to the call center, reconnecting the consumer with the system upon a conclusion of the consumer's business with the call center; and
prompting the consumer to input the consumer's destination phone number.

5. The method according to claim 4, wherein if the consumer chooses not to be connected to the call center, the connecting the consumer to an advertiser associated with the advertisement comprises prompting the consumer to input the consumer's destination phone number.

6. The method according to claim 1, wherein the terminating comprises:
timing a connection between the consumer and the called party; and
providing warnings to the consumer that a time limit is approaching and/or that the connection will be terminated.

7. The method according to claim 1, further comprising prompting the consumer to listen to additional advertisements so as to extend the length of the telephone call.

8. The method according to claim 1, wherein the consumer establishes an account with the system, the account being accessible to the consumer, and is identified by the system as an account holder.

9. The method according to claim 8, wherein the account is accessible via an internet web page as a portal for the consumer to access his/her account and to get additional information from the internet.

10. The method according to claim 9, wherein the consumer may add telephone connection time to his/her account by viewing advertisements broadcast over the internet and/or by authorizing a payment over the internet.

11. The method according to claim 1, further comprising gathering demographic and/or product preference information from the consumer.

12. The method according to claim 1, wherein the connecting the consumer to the called party comprises routing the connection over a Voice over IP (VoIP) network.

13. The method according to claim 12, wherein the routing comprises automatically determining whether to route the call via a Public Switched Telephone Network (PSTN) or a VoIP network based upon the destination of the call and network availability.

14. The method according to claim 12, wherein the routing comprises employing first and second gateways associated with the system, the first gateway being local to the system and the second gateway being local to the called party.

15. The method according to claim 1, further comprising prompting the consumer to enter the telephone number of the party to be called between the accepting and the playing operations, between the playing and the connecting operations, after the consumer is finished dealing with the advertiser associated with the advertisement, or after the consumer decides to be connected only to the party to be called.

16. The method according to claim 1, further comprising:
monitoring the connection to determine if the consumer or the called party manually disconnects the connection or if the connections is accidentally disconnected; and
crediting the consumer for unused telephone call time.

17. An automated telecommunication system connected to a Public Switched Telephone Network (PSTN) and/or a Voice over Packet network, both of which including a first node at which a consumer initiates an incoming telephone call into the system and a second node at which a party to be called is located, comprising:
a free call system to receive the incoming telephone call from the consumer, to play at least one advertisement to the consumer, the advertisement being chosen from a set of advertisements based at least partly upon a geographical location of the consumer and/or preprogrammed logic in the system, or to gather demographic and/or survey information from the consumer, and to connect the consumer to the called party for a period of time based on a number of advertisements played to the consumer or a predetermined period of time.

18. The system according to claim 17, wherein the Voice Over Packet network comprises a Voice over IP (VoIP) network.

19. The system according to claim 17, wherein the free call system comprises:
an inbound path, which carries a voiceband signal to a Dual Tone Multi-Frequency (DTMF) Detector and an Automated Speech Recognition (ASR) module, respectively; and
an outbound path, controlled by a switch which is in turn controlled by a central processor, connected to a recorded message storage or a Text to Speech Synthesizer (TSS).

20. The system according to claim 18, wherein the system employs at least one connection to the PSTN to connect calls over the PSTN and one connection to the VoIP network to connect calls via the VoIP network.

21. The method according to claim 18, wherein the system automatically determines whether to route the call via a PSTN or the VoIP network.

22. The method according to claim 21, wherein the system employs first and second gateways associated with the system to route the call via the VoIP network, the first gateway being local to the system and the second gateway being local to the called party.

23. The system according to claim 17, wherein the consumer establishes an account with the system, the account being accessible to the consumer.

24. The system according to claim 23, wherein the account is accessible via an internet web page as a portal for the consumer to access his/her account and to get additional information from the internet.

25. The system according to claim 24, wherein the consumer may add telephone connection time to his/her account by viewing advertisements broadcast over the internet and/or by authorizing a payment over the internet.

26. The system according to claim 17, wherein the system additionally monitors the connection to determine if the connection is manually disconnected by either the consumer or the called party or to determine if the connection is accidentally termination, and to credit the consumer for any unused telephone call time.

27. A method of operating an automated telecommunication system, comprising:
accepting an incoming telephone call from a consumer to be identified by the system, the consumer being prompted during the incoming telephone call to enter a telephone number of a called party;
playing at least one advertisement to the consumer, the advertisement being chosen from a set of advertisements based upon the identity of the consumer and/or preprogrammed logic in the system;
connecting the consumer to an advertiser associated with the advertisement and then to the called party or connecting the consumer to only the called party based on a preference of the consumer; and
terminating the connection between the consumer and the called party after a predetermined time, wherein the connecting the consumer to the called party comprises routing the connection over a Voice over Packet network.

28. The method according to claim 27, wherein the Voice Over Packet network comprises a Voice over IP (VoIP) network.

29. The method according to claim 28, wherein the routing comprises automatically determining whether to route the call via a Public Switched Telephone Network (PSTN) or a VoIP network based upon the destination of the call and network availability.

30. The method according to claim 27, wherein the routing comprises employing first and second gateways associated with the system, the first gateway being local to the system and the second gateway being local to the called party.

31. The method according to claim 27, further comprising prompting the consumer to enter the telephone of the party to be called between the accepting and the playing operations, between the playing and the connecting operations, after the consumer is finished dealing with the advertiser associated with the advertisement, or after the consumer decides to be connected only to the party to be called.

32. The method according to claim 27, further comprising:
monitoring the connection to determine if the consumer or the called party manually disconnects the connection or if the connections is accidentally disconnected; and
crediting the consumer for unused telephone call time.

33. A method of operating an automated telecommunication system, comprising:
accepting an incoming telephone call from a consumer at a location to be identified by the system who is prompted during the incoming telephone call to enter a telephone number of a party to be called;
playing at least one advertisement to the consumer, the advertisement being chosen from a set of advertisements based at least partly upon the geographical location of the consumer and/or preprogrammed logic in the system, and the number of advertisements being based upon an amount of telephone call time desired by the consumer;
connecting the consumer to an advertiser associated with the advertisement and then to the party to be called or connecting the consumer to only the party to be called based on a preference of the consumer; and
terminating the connection between the consumer and the called party after the amount of telephone call time desired by the consumer has elapsed.

34. The method according to claim 33, further comprising:
monitoring the connection to determine if the consumer or the called party manually disconnects the connection or if the connections is accidentally disconnected; and
crediting the consumer for unused telephone call time.

35. A method of operating an automated telecommunication system, comprising:
accepting an incoming telephone call from a consumer at a location to be identified by the system who is prompted during the incoming telephone call to enter a telephone number of a party to be called;
playing at least one advertisement to the consumer, the advertisement being chosen from a set of advertisements based at least partly upon the geographical location of the consumer and/or preprogrammed logic in the system, and the number of advertisements being based upon an amount of telephone call time desired by the consumer;
connecting the consumer to an advertiser associated with the advertisement and then to the party to be called or connecting the consumer to only the party to be called based on a preference of the consumer; and
terminating the connection between the consumer and the called party after the amount of telephone call time desired by the consumer has elapsed, wherein the connecting the consumer to the called party comprises routing the connection over a Voice over Packet network.

36. The method according to claim 35, wherein the Voice Over Packet network comprises a Voice over IP (VoIP) network.

37. The method according to claim 35, further comprising:
monitoring the connection to determine if the consumer or the called party manually disconnects the connection or if the connections is accidentally disconnected; and
crediting the consumer for unused telephone call time.
